(19) United States
(12) Patent Application Publication
(10) Pub. No.: US 2025/0350116 A1
(43) Pub. Date: Nov. 13, 2025

(54) On Grid and Off Grid Power Controller

(71) Applicant: James C. Gordon, III, San Bernardino, CA (US)

(72) Inventor: James C. Gordon, III, San Bernardino, CA (US)

(21) Appl. No.: 18/660,036

(22) Filed: May 9, 2024

(51) Int. Cl. H02J 3/00; H02J 3/32

(52) U.S. Cl. CPC H02J 3/0075; H02J 3/32

(57) ABSTRACT

A power controller device is disclosed for managing power from a plurality of power sources. The power controller device includes a rigid base storing internal electrical components and a top panel as a user interface. The rigid base includes a first electrical connection port for connecting to a power grid, a second electrical connection port for connecting to a generator, a third electrical connection port for connecting to a load that consumes power, and a controller. The controller is configured to monitor power inputs from the power grid and the generator, and selectively draw power from the power grid and the generator according to a selected operation mode from a plurality of operation modes and based on a load requirement. The top panel includes a manual toggle for selecting of the plurality of operation modes for operating the power controller, and one or more visual indicators for identifying the selected operation mode.

### BACKGROUND

Family homes are increasingly implementing renewable power generators, such as solar panels for capturing solar power and/or turbines to capture wind power. Some homes further include backup power storage units and/or fuel-powered generators. All such power sources are connected to the home, without a device or process to efficiently switch between the add-on sources and the power grid.

### SUMMARY

A power controller serves as a pivotal component in monitoring and managing power from diverse sources. Equipped with sensors, the power controller meticulously observes metrics from each power source, including the power grid and/or one or more generators, which encompasses factors such as power voltage, frequency, and stability. Notably, the power controller integrates an inverter to harmonize the electricity generated by the generator and/or supplied by the power storage unit with the power grid's voltage and frequency specifications. This harmonious interaction fortifies the stability of the overall electrical system, contributing to enhanced grid resilience.

A central controller connects to all power sources to receive and process data and metrics. This controller features transmission and receiving components, fostering communication with external devices, e.g., via a network. The power controller embodies a sophisticated and interconnected infrastructure that not only ensures efficient power utilization but also promotes adaptability and responsiveness to the dynamic conditions of the power grid and associated components.

The power controller offers several advantages in terms of energy efficiency, cost savings, and environmental impact. In addition to providing a reliable power supply, the grid-connected power controller offers homeowners the potential for cost savings through by optimally leveraging power generated by the one or more generators, without sacrificing supply of power to the home. Excess energy generated during periods of low demand can be fed back into the grid, resulting in credits or reduced electricity bills.

### BRIEF DESCRIPTION OF THE DRAWINGS

FIG. 1 illustrates a system environment for a power controller, in accordance with one or more embodiments.

FIG. 2A illustrates a top panel of the power controller including indicators and user inputs, in accordance with one or more embodiments.

FIG. 2B illustrates a base of the power controller including electrical connection points to the various power sources and a circuit board to monitor and manage the power sources, in accordance with one or more embodiments.

FIG. 3 illustrates a block diagram of the power controller's controller architecture, in accordance with one or more embodiments.

FIG. 4 is a flowchart illustrating an auto-selection mode of the controller, in accordance with one or more embodiments.

FIG. 5 is a flowchart illustrating a generator priority mode of the controller, in accordance with one or more embodiments.

FIG. 6 is a flowchart illustrating a power grid priority mode of the controller, in accordance with one or more embodiments.

FIG. 7 is a flowchart illustrating a fail-safe mode of the controller, in accordance with one or more embodiments.

FIG. 8 illustrates an example power controller circuit diagram, according to one or more embodiments.

### DETAILED DESCRIPTION

### Power Controller System Environment

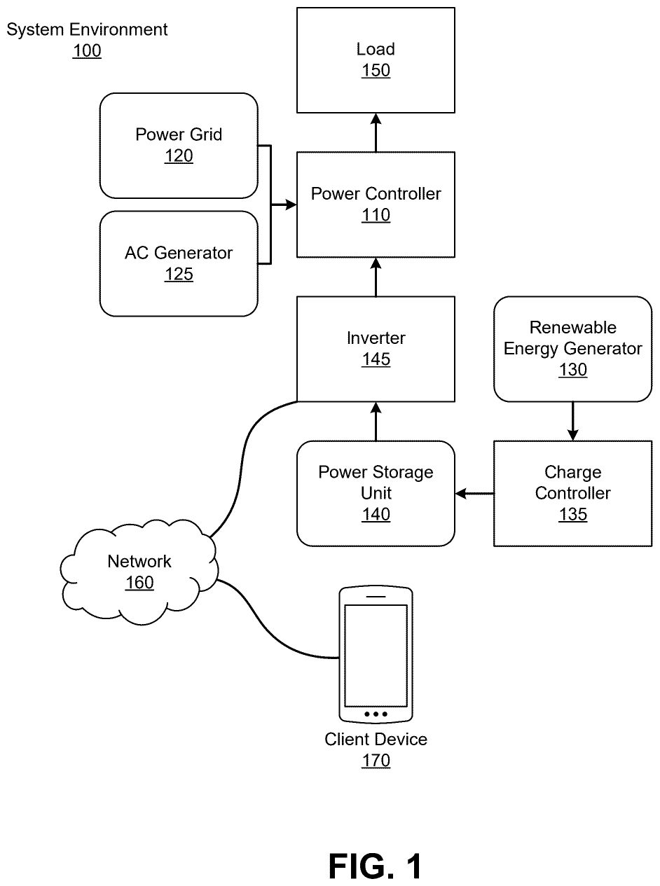

FIG. 1 illustrates a system environment 100 for a power controller 110, in accordance with one or more embodiments. The system environment illustrated in FIG. 1 includes the power controller 110, power grid 120, an alternating current (AC) generator 125, a renewable energy generator 130, a charge controller 135, a power storage unit 140 (“PSU”), an inverter 145, a load 150, a network 160, and a client device 170. The power grid 120, the AC generator 125, the renewable energy generator 130, and the power storage unit 140 are different types of power sources. Each power source can provide power to the power controller 110, e.g., that is generated or stored. Alternative embodiments may include more, fewer, or different components from those illustrated in FIG. 1, and the functionality of each component may be divided between the components differently from the description below. Moreover, each component illustrated in FIG. 1 may be representative of a plurality of like components, wherein each of the plurality may function as described. Additionally, each component may perform their respective functionalities in response to a request from a human, or automatically without human intervention.

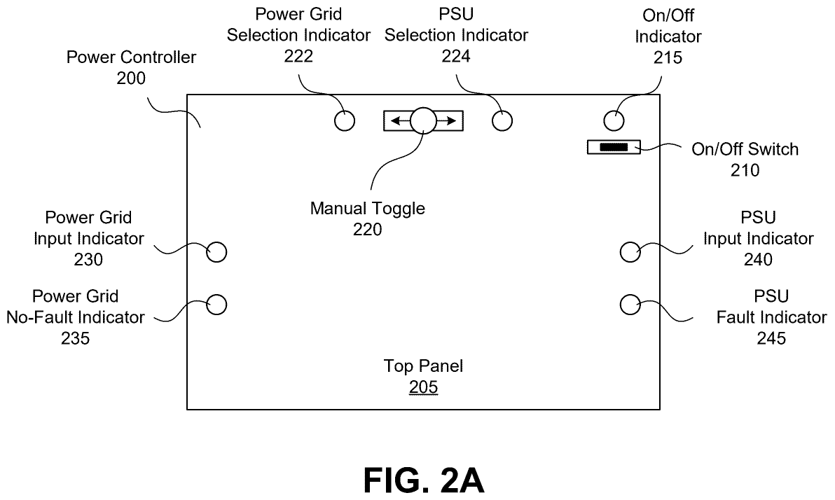

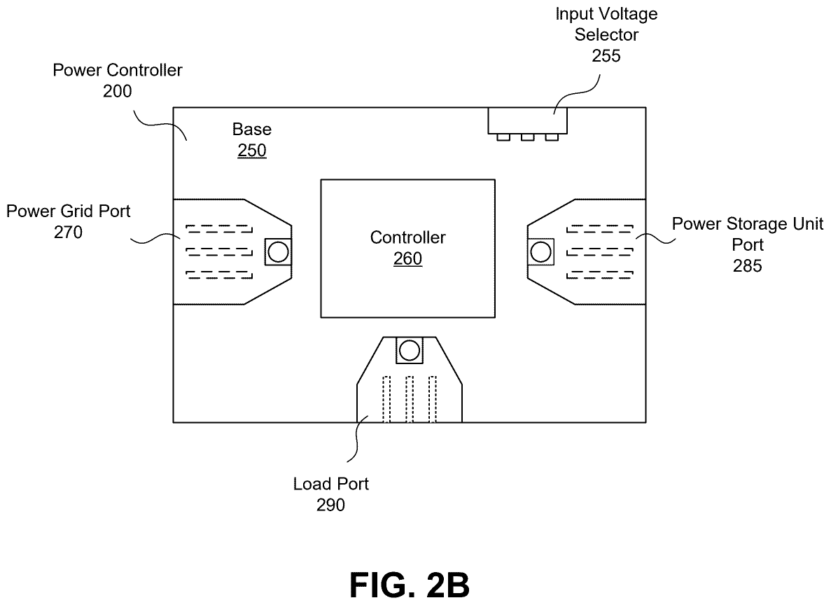

The power controller 110 monitors and manages power provided by the various power sources. The power controller 110 may include sensors to monitor metrics of each power source, as each power source provides power to the power controller 110. For example, the power controller 110 may monitor metrics from the power grid 120, e.g., indicating power voltage, power frequency, power stability, etc. The power controller 110 may include an inverter, which ensures that the electricity generated by the renewable energy generator 130 and/or provided by the power storage unit 140 matches to the power grid 120′s voltage and frequency specifications. This seamless interaction with the grid enhances the stability of the overall electrical system and contributes to grid resilience. The power controller 110 may include a controller, e.g., a computing device, that is connected to each of the power sources to receive data and measurements from the various power sources. The controller may further include transmission and receiving components to communicate with other devices, e.g., via the network 160. Details relating to the power controller 110 are further described in FIGS. 2-8.

The power grid 120 provides power from a utility company. The utility company may generate the power through various approaches, e.g., burning fossil fuels, nuclear power, renewable sources (e.g., hydropower, wind power, solar power, burning biomass), geothermal power, etc. The power is transferred into commercial, retail, and/or residential units through a grid of power lines. The power grid 120 may provide metrics from the utility company to the power controller 110. In some embodiments, the AC generator 125 provides the AC power to the power controller, in a similar role to the power grid 120.

The renewable energy generator 130 generates electrical power from a renewable energy source. The renewable energy generator 130 may include one or more power generation units. Each power generation unit may include a prime mover, such as an internal combustion engine or a renewable energy generator, and an electrical generator. The renewable energy generator 130 may dynamically optimize the operation of the power generation units based on real-time demand, environmental conditions, and other relevant factors. The renewable energy generator 130 may supply electrical power to charge the power storage unit 140, i.e., via the charge controller 135. The renewable energy generator 130 may further include sensors to monitor performance and/or output of the renewable energy generator 130. Example metrics may include output voltage, output frequency, environmental conditions, run-time metrics, emission levels, fault detection, other diagnostics, or some combination thereof.

The power storage unit 140 stores power, e.g., generated by the renewable energy generator 130 and/or provided by the power grid 120. The power storage unit 140 may include one or more batteries, capable of storing charge. A charge controller 135 may aid in charging of the power storage unit 140. The charge controller 135 regulates voltage and/or current to ensure the power storage unit 140 does not overcharge. Accordingly, the charge controller 135 may measure metrics related to the power storage unit 140 and/or the charging process of the power storage unit 140. Based on the metrics, the charge controller 135 may throttle the charging. The power supplied by the power storage unit 140 is typically in direct current. In such embodiments, the power storage unit 140 supplies power to an inverter 145 that converts the power from DC to AC, i.e., in usable form for the load 150. The power storage unit 140 may also include other sensors for measuring metrics of the power storage unit 140. Example metrics may include, an amount of stored charge, anticipated run-time of the stored charge, health of the power storage unit, etc.

The load 150 is an electrical component that consumes power. The load 150 may be a commercial unit, a business unit, or a residential unit. The load 150 may correspondingly include any number of electrical outlets, for providing power to smaller devices, e.g., charging electronic devices, operating appliances, supplying power to lights, etc.

The network 160 is a collection of computing devices that communicate via wired or wireless connections. The network 160 may include one or more local area networks (LANs) or one or more wide area networks (WANs). The network 160, as referred to herein, is an inclusive term that may refer to any or all of standard layers used to describe a physical or virtual network, such as the physical layer, the data link layer, the network layer, the transport layer, the session layer, the presentation layer, and the application layer. The network 160 may include physical media for communicating data from one computing device to another computing device, such as multiprotocol label switching (MPLS) lines, fiber optic cables, cellular connections (e.g., 3G, 4G, or 5G spectra), or satellites. The network 160 also may use networking protocols, such as TCP/IP, HTTP, SSH, SMS, or FTP, to transmit data between computing devices. In some embodiments, the network 160 may include Bluetooth or near-field communication (NFC) technologies or protocols for local communications between computing devices. The network 160 may transmit encrypted or unencrypted data.

The client device 170 is a computing device used by a user. The client device 170 may be communicatively coupled to the power controller 110, e.g., to provide input to the power controller 110 and/or to receive information from the power controller 110. For example, the user may, via the client device 170, select the power controller 110 to operate in one of the available modes. The power controller 110 may, subsequently, provide confirmation of the mode selection. During operation, the power controller 100 may also provide to the client device 170 reports or notifications regarding the operation of the power controller 100.

### Power Controller

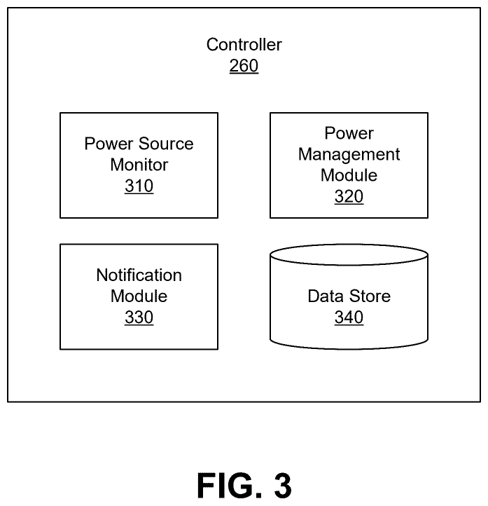

FIGS. 2A, 2B, and 3 include additional details of the power controller. In particular, FIGS. 2A & 2B illustrate exemplary hardware schematics of the power controller as a device. FIG. 3 is a block diagram illustrating a software architecture of the controller that operates the power controller.

FIG. 2A illustrates a top panel 205 of the power controller 200 including indicators and user inputs, in accordance with one or more embodiments. The top panel 205 may be coupled atop the base (e.g., as shown in FIG. 2B). The top panel includes the indicators for notifying a user of an operation status of the power controller 200, and the inputs for allowing the user to adjust the operation of the power controller 200. In FIG. 2A, the inputs include the on/off switch 210 and the manual toggle 220; and the indicators include the on/off indicator 215, the power grid selection indicator 222, the PSU selection indicator 224, the power grid input indicator 230, the power grid no-fault indicator 235, the PSU input indicator 240, and the PSU fault indicator 245. In other embodiments, there could be additional, fewer, or different components than those listed herein. For example, there could be additional indicators to show the power storage unit charge level, etc.

The on/off switch 210 is a switch to permit switching the power controller 200 on and off. The switch 210 may be a physical button that can be depressed. For example, the button can have two configurations, a depressed configuration for the on state and an undepressed configuration for the off state. As another example, each press of the button toggles the power controller 200 into the alternate state, such that pressing the button when the power controller 200 is in the off state would transition the power controller 200 into the on state.

The on/off indicator 215 provides visual indication of the power controller 200's status. For example, the on/off indicator 215 may be a light that is on corresponding to the power controller 200 being in the on state, or is off corresponding to the power controller 200 being in the off state. As another example, the on/off indicator 215 may shine different colors for the on state versus the off state. In some embodiments, the visual indication may be personalized, e.g., according to input by the user via their client device.

The manual toggle 220 provides an input for the user to select an operation mode of the power controller 200. In the example shown in FIG. 2A, the manual toggle includes a toggle that can be moved between a plurality of operation modes. The plurality of operation modes may include a power grid priority mode, a generator priority mode, and, optionally, an auto-selection mode. In other embodiments, the user may provide the selection digitally, e.g., via a client device communicatively coupled to the power controller 200.

The power grid selection indicator 222 and the PSU selection indicator 224 provide visual indication to the operation mode of the power controller 200. For example, if the power controller 200 is in the power grid priority mode, the power grid selection indicator 222 may be on and emitting light, whereas the PSU selection indicator 224 may be off and not emitting light. In the example of the auto-selection mode, the corresponding selection indicator may be on based on which power source the power controller 200 is drawing power from.

The power grid input indicator 230 and the power grid no-fault indicator 235 provide visual indication regarding status of the power grid. The status may further include metrics regarding the power source. The power grid input indicator 230 may provide visual indication as to the current power input status of the power grid. For example, if the power controller 200 detects power input from the power grid, the power grid input indicator 230 may be on and emitting light. Conversely, if the power controller 200 does not detect power input from the power grid, the power grid input indicator 230 may be off and not emitting light. Similarly, for the power grid no-fault indicator 235, the power grid no-fault indicator 235 may provide indication as no-faults are detected. If there is no-fault detected, the power grid indicator 235 may be on and emitting light. If there is fault, the power grid no-fault indicator 235 may be off and not emitting light. In other embodiments, the power grid no-fault indicator 235 may operate oppositely as described above, i.e., the indicator is a fault indicator.

The PSU input indicator 240 and the PSU fault indicator 245 provide visual indication regarding status of the power storage unit and/or the generator. The status may further include metrics regarding the power storage unit and/or the generator. The PSU input indicator 240 may provide visual indication as to the current power input status of the power storage unit and/or the generator. For example, if the power controller 200 detects power input from the power storage unit, the PSU input indicator 240 may be on and emitting light. Conversely, if the power controller 200 does not detect power input from the power storage unit, the PSU input indicator 240 may be off and not emitting light. Similarly, for the PSU fault indicator 245, the PSU fault indicator 245 may provide indication as faults are detected. If there is fault detected, the PSU fault indicator 245 may be on and emitting light. If no fault is detected, the PSU fault indicator 245 may be off and not emitting light. In other embodiments, the PSU fault indicator 245 may operate oppositely as described above, i.e., the indicator is a no-fault indicator.

FIG. 2B illustrates a base 250 of the power controller 200 including electrical connection ports to the various power sources and a circuit board to monitor and manage the power sources, in accordance with one or more embodiments. As shown in FIG. 2B, the base 250 includes an input voltage selector 255, a controller 260, a power grid port 270, a generator port 280, and a load port 290. In other embodiments, there could be additional, fewer, or different components than those listed herein. For example, there could be additional electrical ports for additional generators, for additional power storage units, and/or for additional loads.

The base 250 is a housing unit that stores internal electrical components of the power controller 200. The top panel 205 couples to the base 250, with the various inputs and indicators on the top panel 205 connected to the controller 260. Accordingly, the controller 260 receives inputs from the top panel 205 and provides activation instructions for the indications on the top panel 205.

The controller 260 is a computing device that manages operation of the power controller 200. As a computing device, the controller 260 may include at least a computer processor and a non-transitory computer-readable storage medium with encoded computer-readable instructions. The controller 260 generally receives inputs manually (e.g., on the top panel 205) or digitally (e.g., via a client device) to modify operation of the power controller 200. The controller 260 also generally receives metrics from the various power sources to determine which of the power sources to draw power from and if/when to provide notifications to the user. The controller 260 also generally directs power from the power sources to the power outlet 290. Further details of the controller 260 are described in FIG. 3.

The input voltage selector 255 is a user-togglable switch that controls output power voltage to the load port 290. The input voltage selector 255 may include options for supporting different power voltages. This is advantageous in adapting the power controller 200 to support different load requirements. For example, the power controller 200 can be toggled to support 12V, 24V, or 36V loads. The input voltage selector 255 may be further electrically coupled to one or more fuses as safety measures to prevent failure of the power controller 200.

The electrical connection ports provide points of connection between the power controller 200 and the external components. The power grid port 270 is an electrical connection port for connecting to the power grid. The power storage unit port 280 is an electrical connection port for connecting to the power storage unit. The load port 290 is an electrical connection port for connecting to the load. Each port may include a male or a female electrical connector. For example, the port can be a three-pronged male connector, or any other type of electrical connector.

FIG. 3 illustrates a block diagram of the power controller's controller 260 architecture, in accordance with one or more embodiments. The controller 260 includes a power source monitor 310, a power management module 320, a notification module 330, and a data store 340. In other embodiments, there could be additional, fewer, or different modules than those listed herein. Moreover, the functionality may be variably distributed than as described herein.

The power source monitor 310 monitors the various power input and metrics of the power sources. The power source monitor 310 may track the power input from each power source. The power input over time may be tracked and stored in the data store 340. The power source monitor 310 may also track other metrics of each power source. For example, the power source monitor 310 may track timing of faults, e.g., which may be used for predicting future faults.

The power management module 320 directs power drawn from the power sources based on the operation mode of the power controller and the monitored power inputs. The power management module 320 may operate in one of a plurality of operation modes. In a power grid priority mode, the power management module 320 prioritizes drawing power from the power grid. Accordingly, if the power grid's power input is capable of providing for the power needed by the load, the power management module 320 may draw power from the power grid. If the power input is insufficient, then the power management module 320 may draw from the other power sources, e.g., the generator or the power storage unit. The power grid priority mode is advantageous in situations where the other power sources may not have lengthy endurance, or may provide lesser amounts of power. In a generator priority mode, the power management module 320 prioritizes drawing power from the power storage unit and/or the generator. If the power storage unit's power input is sufficient, the power management module 320 will supply the load with power from the power storage unit. If the power input is insufficient, the power management module 320 may switch to the power grid (e.g., automatic switch to on grid). The generator priority mode is advantageous in reducing reliance on the power grid, e.g., creating cost-saving benefits. In the auto-selection mode, the power management module 320 automatically balances the load between the various power sources. In this mode, the power management module 320 may seek to optimize use of the generator and/or the power storage unit whilst supplementing with the power grid when needed. The power management module 320 may also optimize based on the metrics, e.g., to lean towards stability of the provision of power. In a fail-safe mode, the power grid may be inoperable (e.g., there's a blackout in the power grid). In response to the fail-safe mode, the power management module 320 may notify the user of the fail-safe mode.

The notification module 330 provides notifications. In some embodiments, the power controller may include the physical indicators, e.g., visual indicators, audio indicators, haptic indicators, or some combination thereof. In other embodiments, the power controller may be communicatively coupled to the user's client device, providing digital notifications to the user. The notifications may indicate various status updates of the power controller. For example, the notifications may provide confirmation of the power controller switching into a selected operation mode. The notifications may also provide reports on the metrics of the power sources, e.g., can report that the power grid is suspected to have a brownout in the near future.

The data store 340 stores data used by the controller 260. For example, the data store 340 may track the metrics or power input of the various power sources over time. The data store 340 may also track power usage by the load over time. The data store 340 may also store user preferences in operation of the power controller. The data store 340 may store other data used by the various modules of the controller 260.

### Example Methods

The following description relate to various methods performable by the controller of the power controller. The methods describe different operation modes of the power controller, e.g., the auto-selection mode, the PSU priority mode, the power grid priority mode, and the fail-safe mode. Each flowchart may include additional, fewer, or different steps than those listed. Further, the steps may be reordered.

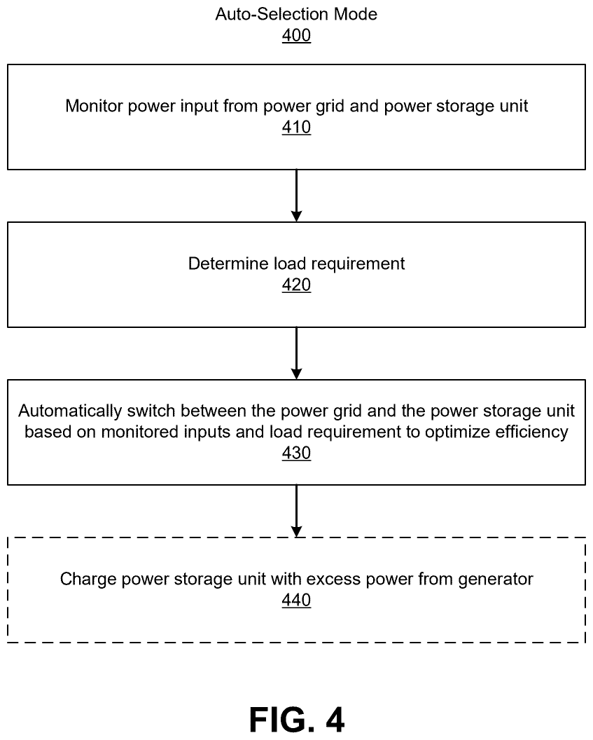

FIG. 4 is a flowchart illustrating an auto-selection mode of the controller, in accordance with one or more embodiments.

The controller monitors 410 power input from the power grid and the PSU. The power input may be measured in voltage, current, watt, kilowatt-hour, another electrical measure, or some combination thereof. The controller may further monitor the stability of the input power, e.g., if there's frequent disruptions, the input power may be deemed unstable.

The controller determines 420 a load requirement. The load requires and consumes power. The controller may assess what the current load requirement based on voltage and current requirements from devices connected to the load.

The controller automatically switches 430 between the power grid and the PSU based on monitored inputs and the load requirement to optimize efficiency. Assuming both power sources are providing sufficient power inputs, the controller may utilize other data measurements to assess which power source to draw from. In some embodiments, the controller prioritizes stability in the power supplied to the load. In such embodiments, the controller can supply whichever load has higher stability in the input power. In other embodiments, the controller may be informed by the fee scheme for the power drawn from the power grid. The controller may avoid drawing power from the power grid during portions of the day above a threshold cost. The controller may also determine when to draw power from the power storage unit. For example, if the power storage unit is full, the controller can selectively draw power from the power storage unit until a threshold level.

The controller may charge 440 the power storage unit with excess power from the PSU. For example, if the PSU is generating excess power than the load requirement, the controller may divert excess power to charge the power storage unit.

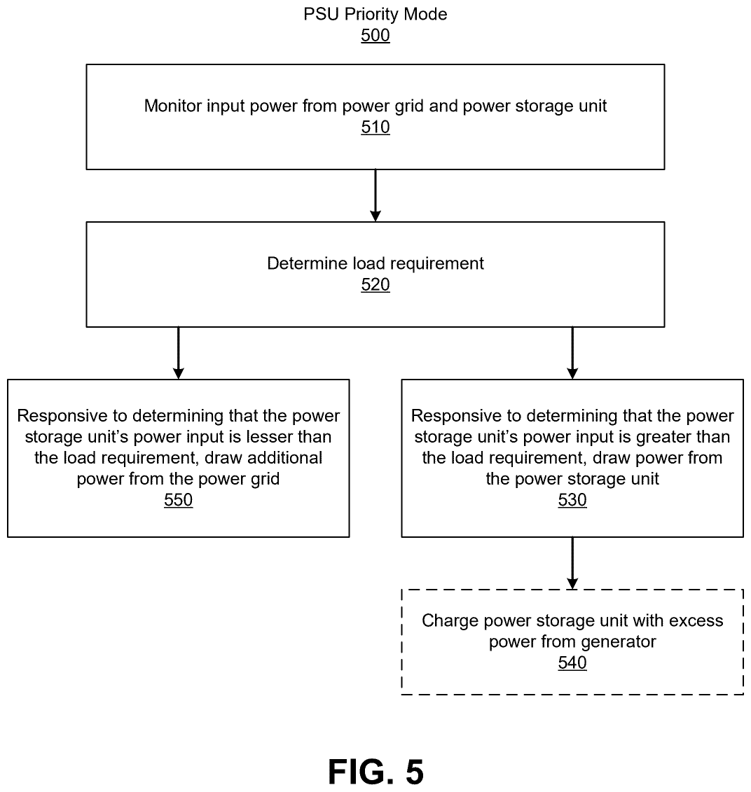

FIG. 5 is a flowchart illustrating a PSU priority mode of the controller, in accordance with one or more embodiments.

The controller monitors 510 power input from the power grid and the PSU. The power input may be measured in voltage, current, watt, kilowatt-hour, another electrical measure, or some combination thereof. The controller may further monitor the stability of the input power, e.g., if there's frequent disruptions, the input power may be deemed unstable.

The controller determines 520 a load requirement. The load requires and consumes power. The controller may assess what the current load requirement based on voltage and current requirements from devices connected to the load.

Responsive to determining that the PSU's power input is greater than the load requirement, the controller draws 530 power from the PSU. In such mode, the controller prioritizes drawing power from the PSU. The controller may charge 540 the power storage unit with excess power from the PSU 540.

Responsive to determining that the PSU's power input is less than the load requirement, the controller draws 550 additional power from the power grid. In some embodiments, the controller can draw all power generated by the PSU and supplement with power from the power grid to suffice the load requirement. In other embodiments, the controller can switch over to drawing power only from the power grid. Any excess power from the PSU may be diverted to charging the power storage unit.

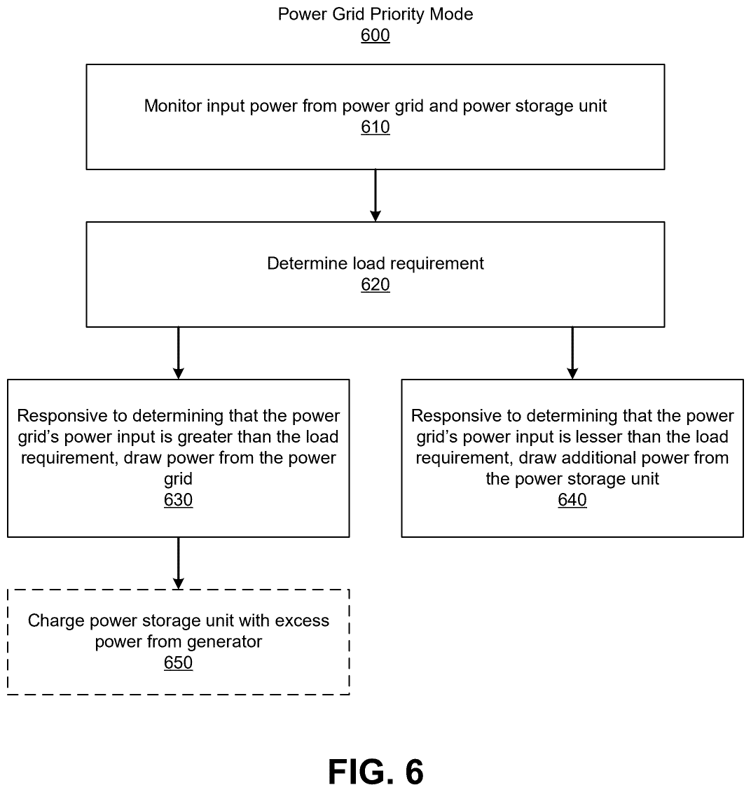

FIG. 6 is a flowchart illustrating a power grid priority mode of the controller, in accordance with one or more embodiments.

The controller monitors 610 power input from the power grid and the PSU. The power input may be measured in voltage, current, watt, kilowatt-hour, another electrical measure, or some combination thereof. The controller may further monitor the stability of the input power, e.g., if there's frequent disruptions, the input power may be deemed unstable.

The controller determines 620 a load requirement. The load requires and consumes power. The controller may assess what the current load requirement based on voltage and current requirements from devices connected to the load.

Responsive to determining that the power grid's power input is greater than the load requirement, the controller draws 630 power from the power grid. In such mode, the controller prioritizes drawing power from the power grid. The controller may charge the power storage unit with excess power from the power grid.

Responsive to determining that the power grid's power input is less than the load requirement, the controller draws 640 additional power from the power storage unit and/or the generator. In some embodiments, the controller can draw all power generated by the power grid and supplement with power from the PSU to suffice the load requirement. In other embodiments, the controller can switch over to drawing power only from the PSU.

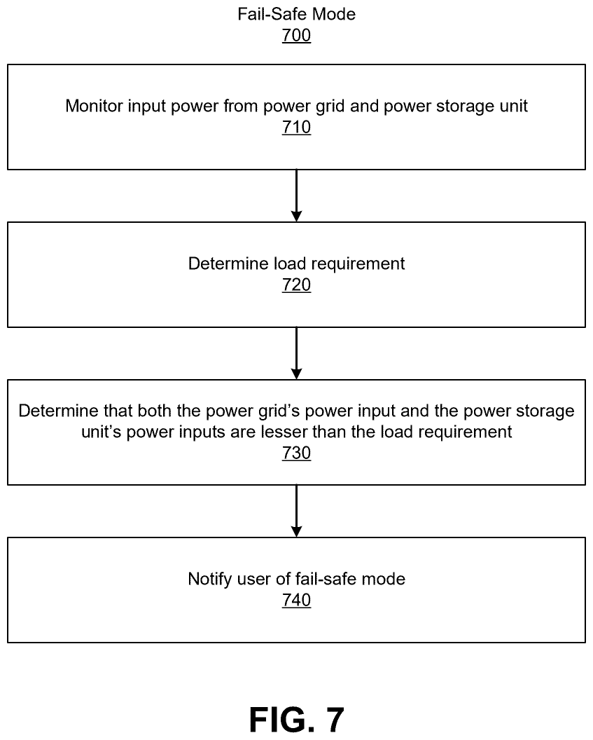

FIG. 7 is a flowchart illustrating a fail-safe mode of the controller, in accordance with one or more embodiments.

The controller monitors 710 power input from the power grid and the PSU. The power input may be measured in voltage, current, watt, kilowatt-hour, another electrical measure, or some combination thereof. The controller may further monitor the stability of the input power, e.g., if there's frequent disruptions, the input power may be deemed unstable.

The controller determines 720 a load requirement. The load requires and consumes power. The controller may assess what the current load requirement based on voltage and current requirements from devices connected to the load.

The controller determines 730 that both the power grid input and the PSU input is less than the load requirement. In some embodiments, the controller determines that the combination of both power inputs is lower than the load requirement, i.e., requiring backup power.

Responsive to determining that the power grid input and the PSU input is less than the load requirement, the controller notifies 740 the user of the fail-safe mode. The notification may be in the form of physical indicators or digital notifications. The controller may also inform or prompt the user to reduce the load requirement. In some embodiments, the controller may inform the user of an anticipated runtime of the power storage unit serving in the backup capacity if the current load requirement persists. For example, “Assuming your current energy needs persist, the backup battery can continue to supply power to your home for the next 20 hours.” Such notification provides added insight to aid the user in managing power consumption to ride out the fail-safe mode.

### Example Power Controller Circuit Diagram

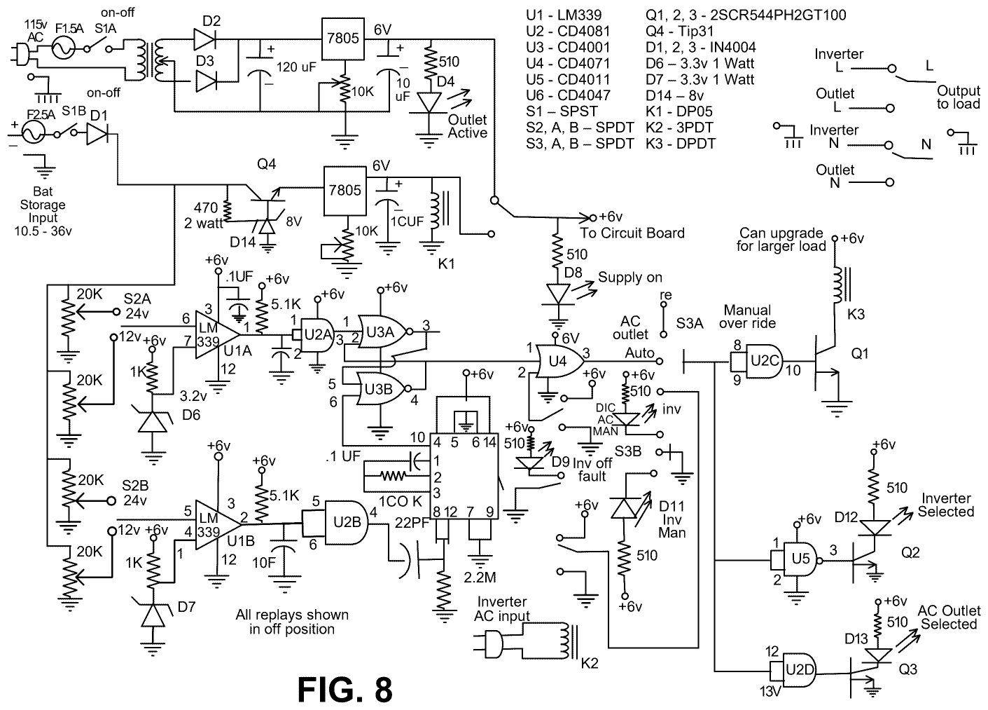

FIG. 8 illustrates an example power controller circuit diagram, according to one or more embodiments. As described throughout, the power controller is configured to sense power levels from one or more power sources, and to switch between power sources to draw power from in supplying power to a load. The power controller may also be toggled to operate in different priority modes to prioritize drawing power from one power source, unless that power source is deficient, causing the power controller to switch to drawing power from a source of secondary priority. Furthermore, the power controller can switch output voltages based on input by the user.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more subprocessing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A power controller device comprising:
a rigid base comprising:
a first electrical connection port for connecting to a power grid,
a second electrical connection port for connecting to a generator,
a third electrical connection port for connecting to a load that consumes power, and
a controller configured to:
monitor power inputs from the power grid and the generator, and
selectively draw power from the power grid and the generator according to a selected operation mode from a plurality of operation modes and based on a load requirement;
a top panel coupled to the rigid base and comprising:
a manual toggle for selecting of the plurality of operation modes for operating the power controller, the manual toggle movable between three different positions.
wherein a first position of the manual toggle configures the controller to operate in a power grid priority mode to prioritize drawing power from the power grid,
wherein a second position of the manual toggle configures the controller to operate in an auto-selection mode to automatically select whether to draw power from the power grid or the generator, and
wherein a third position of the manual toggle configures the controller to operate in a generator priority mode to prioritize drawing power from the generator, and
one or more visual indicators for identifying the selected operation mode.

2. The power controller of claim 1, the top panel based further comprising:
an on/off switch configured to switch the power controller between an on state and an off state,
wherein the one or more visual indicators include an on/off indicator configured to provide a first visual indication corresponding to the on state and a second visual indication corresponding to the off state.

3. The power controller of claim 1, wherein the one or more visual indicators include:
a first indicator configured to provide indication that the power controller is in the power grid priority mode of the plurality of operation modes; and
a second indicator configured to provide indication that the power controller is in the generator priority mode of the plurality of operation modes.

4. The power controller of claim 3, wherein the one or more indicators further include:
a third indicator configured to provide indication that the power grid is actively supplying power; and
a fourth indicator configured to provide indication that the generator is actively supplying power.

5. The power controller of claim 4, wherein the one or more indicators further include:
a fifth indicator configured to provide indication of fault status of the power grid; and
a sixth indicator configured to provide indication of fault status of the generator.

6. The power controller of claim 5, wherein the one or more indicators further include:
a seventh indicator configured to provide indication of a power level of a power storage unit connected to the power controller.

7. The power controller of claim 1, the controller further configured to, in the auto-selection mode of the plurality of operation modes:
automatically switch between drawing power from the power grid and the generator based on power inputs from the power grid and the generator in comparison to the load requirement.

8. The power controller of claim 1, the controller further configured to, in the power grid priority mode of the plurality of operation modes:
responsive to determining that the power input from the power grid is greater than the load requirement, drawing power from the power grid to supply to the load; and
responsive to determining that the power input from the power grid is less than the load requirement, drawing power from the generator to supply to the load.

9. The power controller of claim 1, the controller further configured to, in the generator priority mode of the plurality of operation modes:
responsive to determining that the power input from the generator is greater than the load requirement, drawing power from the generator to supply to the load; and
responsive to determining that the power input from the generator is less than the load requirement, drawing power from the power grid to supply to the load.

10. The power controller of claim 1, the rigid base further comprising:
a fourth electrical connection port for connecting to a power storage unit capable of storing power.

11. The power controller of claim 10, the controller further configured to:
charge the power storage unit with excess charge from either the power grid or the generator.

12. The power controller of claim 10, the controller further configured to, in a fail-safe mode of the plurality of operation modes:
responsive to determining that the power inputs from the generator and the power grid is less than the load requirement, drawing power from the power storage unit to supply to the load.

13. The power controller of claim 12, the controller further configured to, in the fail-safe mode:
transmit a notification to a client device of a user of the power controller to notify the user of activation of the fail-safe mode.

14. A non-transitory computer-readable storage medium storing instructions that, when executed by a computer processor, cause the computer processor to perform operations comprising:
monitoring power inputs from a power grid and a generator electrically connected to a power controller;
determining a load requirement from power drawn by a load electrically connected to the power controller;
automatically switching between the power grid and the generator to supply power to the load, by:
responsive to determining that the power input of the power grid is less than the load requirement, supplying power from the generator to the load, and
responsive to determining that the power input of the generator is less than the load requirement, supplying power from the power grid to the load.

15. The non-transitory computer-readable storage medium of claim 14, wherein automatically switching between the power grid and the generator further comprises, responsive to determining that the power input of the power grid and the power input of the generator is greater than the load requirement:
determining stability of the power input from the power grid and stability of the power input from the generator; and
selecting the power grid or the generator having the higher stability.

16. The non-transitory computer-readable storage medium of claim 14, the operations further comprising:
charging a power storage unit electrically connected to the power controller with excess power from the generator.

17. The non-transitory computer-readable storage medium of claim 16, the operations further comprising:
responsive to determining that a combination of the power input of the power grid and the power input of the generator is less than the load requirement, activating a fail-safe mode and drawing power from the power storage unit to supply to the load.

18. The non-transitory computer-readable storage medium of claim 17, the operations further comprising:
transmitting a notification to a user indicating activation of the fail-safe mode.

19. The non-transitory computer-readable storage medium of claim 18, wherein the notification further indicates a predicted runtime provided by the power storage unit based on the load requirement and a power level of the power storage unit.

20. A method comprising:
monitoring power inputs from a power grid and a generator electrically connected to a power controller;
determining a load requirement from power drawn by a load electrically connected to the power controller;
automatically switching between the power grid and the generator to supply power to the load, by:
responsive to determining that the power input of the power grid is less than the load requirement, supplying power from the generator to the load,
responsive to determining that the power input of the generator is less than the load requirement, supplying power from the power grid to the load, and
responsive to determining that the power input of the power grid and the power input of the generator is greater than the load requirement, determining stability of the power input from the power grid and stability of the power input from the generator, and selecting the power grid or the generator having the higher stability.
